(19) United States
(12) Patent Application Publication
(10) Pub. No.: US 2026/0095727 A1
(43) Pub. Date: Apr. 2, 2026

(54) METHOD FOR TRANSFERRING CALL WHEN CHANGING ACCESS MODES AND ELECTRONIC DEVICE PERFORMING THE METHOD

(71) Applicant: Samsung Electronics Co., Ltd., Suwon-si (KR)

(72) Inventors: Duc Doan NGUYEN, Hanoi (VN); Van Hau TRUONG, Hanoi (VN); Van Hung NGUYEN, Hanoi (VN); The Thoi NGUYEN, Hanoi (VN); Van Thinh NGUYEN, Hanoi (VN)

(21) Appl. No.: 19/257,220

(22) Filed: Jul. 1, 2025

(30) Foreign Application Priority Data
Sep. 27, 2024 (KR) 10-2024-0132111

(51) Int. Cl. H04W 4/16; H04W 4/80

(52) U.S. Cl. CPC H04W 4/16; H04W 4/80

(57) ABSTRACT

According to an embodiment, a method performed by an electronic device includes, while performing a call service with a first external electronic device using a first access mode as an access mode set for the electronic device, receiving a command to change the access mode set for the electronic device from the first access mode to a second access mode, transferring a call with the first external electronic device to a second external electronic device connected to the electronic device, based on the call being transferred to the second external electronic device, deactivating the first access mode, and activating the second access mode.

### CROSS-REFERENCE TO RELATED APPLICATIONS

This application is based on and claims priority under 35 U.S. C. § 119 to Korean Patent Application No. 10-2024-0132111, filed on Sep. 27, 2024, in the Korean Intellectual Property Office, the disclosure of which is incorporated by reference herein in its entirety.

### BACKGROUND

### 1. Field

The disclosure relates to technology for transferring a call made between electronic devices, and for example, to technology for transferring a call using an electronic device supporting a plurality of access modes.

### 2. Description of Related Art

A standalone non-public network (SNPN) may be an example of a private 5th-generation (5G) network distributed to be not subordinate to a public land mobile network (PLMN). In a general state, an electronic device operates in a PLMN access mode and may use a PLMN service through 3rd-generation partnership project (3GPP) access. The electronic device needs to operate in an SNPN access mode to use an SNPN service through the 3GPP access. The electronic device may support both the PLMN service and the SNPN service through 3GPP access. However, the electronic device may not operate the PLMN access mode and an SNPN access mode at the same time through 3GPP access (see, e.g., 3GPP TS 23.122) and may not support a handover between the SNPN and the PLMN (see, e.g., 3GPP TS 23.501). Accordingly, the electronic device may operate the PLMN access mode and the SNPN access mode selectively. In other words, the electronic device may not use the PLMN service at the same time while making an SNPN call through the SNPN access mode.

### SUMMARY

According to an example embodiment, an electronic device includes: at least one processor, comprising processing circuitry, and a memory including one or more storage media storing instructions, wherein the instructions, when executed individually or collectively by the at least one processor, cause the electronic device to: while performing a call service with a first external electronic device using a first access mode as an access mode set for the electronic device, receive a command to change the access mode set for the electronic device from the first access mode to a second access mode. The instructions, when executed individually or collectively by the at least one processor, cause the electronic device to: transfer a call with the first external electronic device to a second external electronic device connected to the electronic device; based on the call being transferred to the second external electronic device. The instructions, when executed individually or collectively by the at least one processor, cause the electronic device to: deactivate the first access mode. The instructions, when executed individually or collectively by the at least one processor, cause the electronic device to: activate the second access mode.

According to an example embodiment, a method performed by an electronic device includes: while performing a call service with a first external electronic device using a first access mode as an access mode set for the electronic device, receiving a command to change the access mode set for the electronic device from the first access mode to a second access mode. The method includes transferring a call with the first external electronic device to a second external electronic device connected to the electronic device. The method includes based on the call being transferred to the second external electronic device, deactivating the first access mode. The method includes activating the second access mode.

According to an example embodiment, a non-transitory computer-readable storage medium stores one or more programs including instructions executing the method of the electronic device.

According to an example embodiment, an electronic device includes: at least one processor, comprising processing circuitry, and a memory including one or more storage media storing instructions, wherein the instructions, when executed individually or collectively by the at least one processor, cause the electronic device to: while a first external electronic device is performing a call service with a second external electronic device using a first access mode as an access mode, receive a message requesting transfer of a call from the first external electronic device. The instructions, when executed individually or collectively by the at least one processor, cause the electronic device to: transmit a call invitation message to the second external electronic device. The instructions, when executed individually or collectively by the at least one processor, cause the electronic device to: receive a call acceptance message in response to the call invitation message from the second external electronic device. The instructions, when executed individually or collectively by the at least one processor, cause the electronic device to: transmit a call transfer acceptance message in response to the call acceptance message from the first external electronic device. The instructions, when executed individually or collectively by the at least one processor, cause the electronic device to: perform a call service with the second external electronic device.

According to an example embodiment, a method performed by an electronic device includes: while a first external electronic device is performing a call service with a second external electronic device using a first access mode as an access mode, receiving a message requesting transfer of a call from the first external electronic device. The method includes transmitting a call invitation message to the second external electronic device. The method includes receiving a call acceptance message in response to the call invitation message from the second external electronic device. The method includes transmitting a call transfer acceptance message in response to the call acceptance message from the first external electronic device. The method includes and performing a call service with the second external electronic device.

According to an example embodiment, a non-transitory computer-readable storage medium stores one or more programs including instructions executing the method of the electronic device.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example electronic device in a network environment according to an embodiment;

FIG. 2A is a diagram illustrating an example method of providing a call between electronic devices while an electronic device operates in a non-public network (NPN) access mode, according to an embodiment;

FIG. 2B is a diagram illustrating an example method of transferring a call provided between electronic devices as an electronic device operates in a public land mobile network (PLMN) access mode, according to an embodiment;

FIG. 3 is a flowchart illustrating an example method of transferring a call when an electronic device changes an access mode, according to an embodiment;

FIG. 4 is signal flow diagram illustrating an example method of transferring a call when an electronic device changes an access mode, according to an embodiment;

FIG. 5 is a diagram illustrating an example method of changing an access mode set for an electronic device and a wearable device to transfer a call, according to an embodiment; and

FIG. 6 is a flowchart illustrating an example method of receiving transfer of a call made by an external electronic device, according to an embodiment.

### DETAILED DESCRIPTION

Hereinafter, various example embodiments of the present disclosure will be described in greater detail with reference to the accompanying drawings. However, this is not intended to limit the present disclosure to specific embodiments, and it should be understood that various modifications, equivalents, and/or alternatives of the various example embodiments of the present disclosure are included.

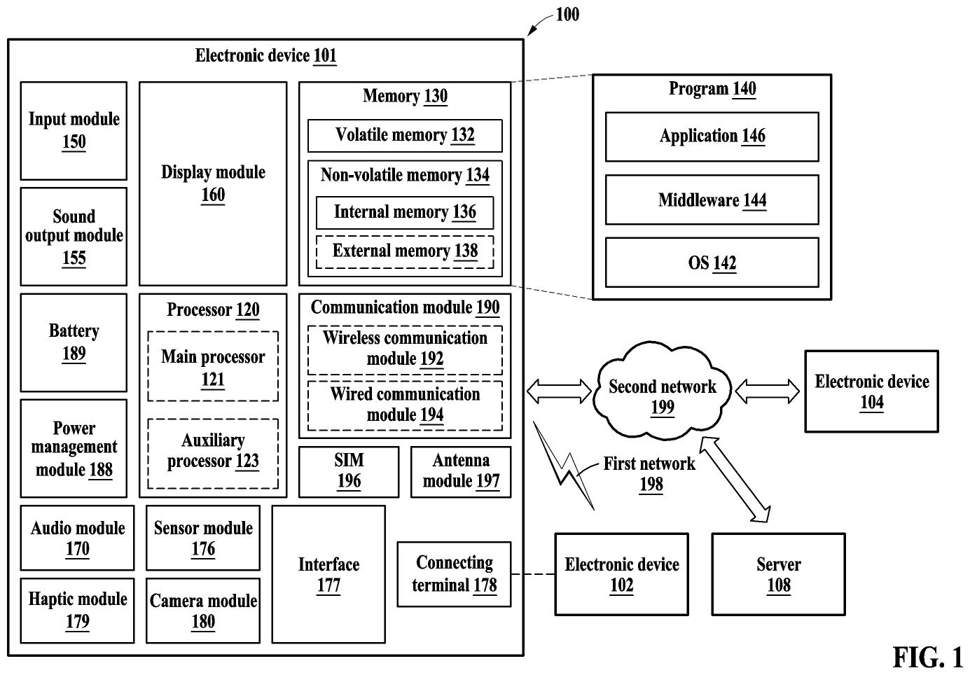

FIG. 1 is a block diagram illustrating an example electronic device in a network environment according to an embodiment.

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In various examples, at least one (e.g., the connecting terminal 178) of the above components may be omitted from the electronic device 101, or one or more other components may be added in the electronic device 101. In various examples, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computation. According to an embodiment, as at least a portion of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)) and/or an auxiliary processor 123 (e.g., a graphics processing unit (GPU), a neural processing unit (NPU), an image signal processor, a sensor hub processor, or a communications processor) that may operate independently from, or in conjunction with the main processor. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one (e.g., the display module 160, the sensor module 176, or the communication module 190) of the components of the electronic device 101 instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence (AI) model processing. An AI model may be generated by machine learning. The machine learning may be performed by, for example, the electronic device 101, in which AI is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but examples are not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, and the projector. According to an embodiment, the display device 160 may include a touch sensor adapted to sense a touch or a pressure sensor adapted to measure the intensity of a force incurred by the touch.

The audio module 170 may convert a sound into an electric signal or vice versa. According to an embodiment, the audio module 170 may obtain the sound via the input module 150 or may output the sound via the sound output module 155 or an external electronic device (e.g., an electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101 and may generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used by the electronic device 101 to couple with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus, which may be recognized by a user via their tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell that is not rechargeable, a secondary cell that is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or IR data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip) or may be implemented as multi-components (e.g., multi-chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, for example, new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, for example, a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beamforming, or a large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as a portion of the antenna module 197.

According to an embodiment, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to an embodiment, all or some of operations to be executed by the electronic device 101 may be executed at one or more external electronic devices (e.g., the external devices 102 and 104, and the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or service. The one or more external electronic devices receiving the request may perform the at least part of the function or service, or an additional function or an additional service related to the request and may transfer a result of the performance to the electronic device 101. The electronic device 101 may provide the result, with or without further processing the result, as at least part of a response to the request. To that end, cloud computing, distributed computing, mobile edge computing (MEC), or client-server computing technology may be used, for example. The electronic device 101 may provide ultra-low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

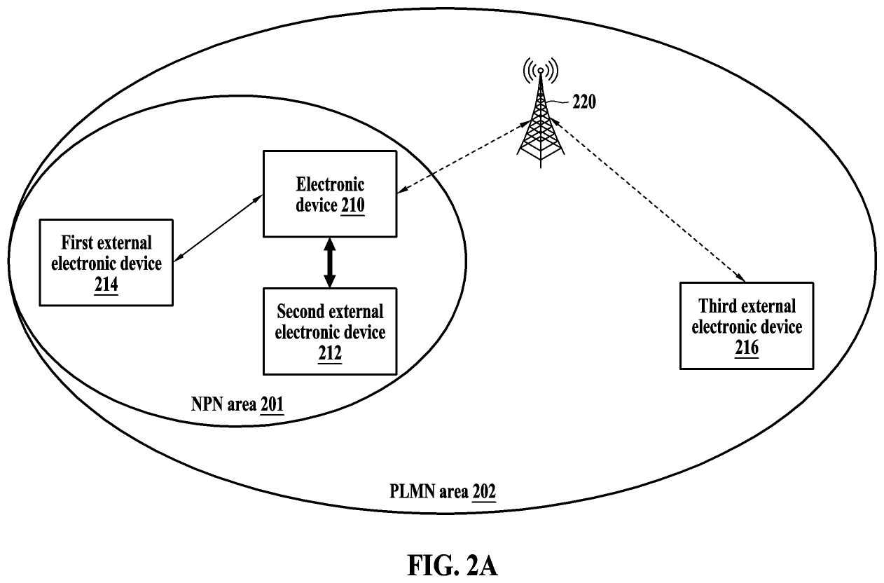

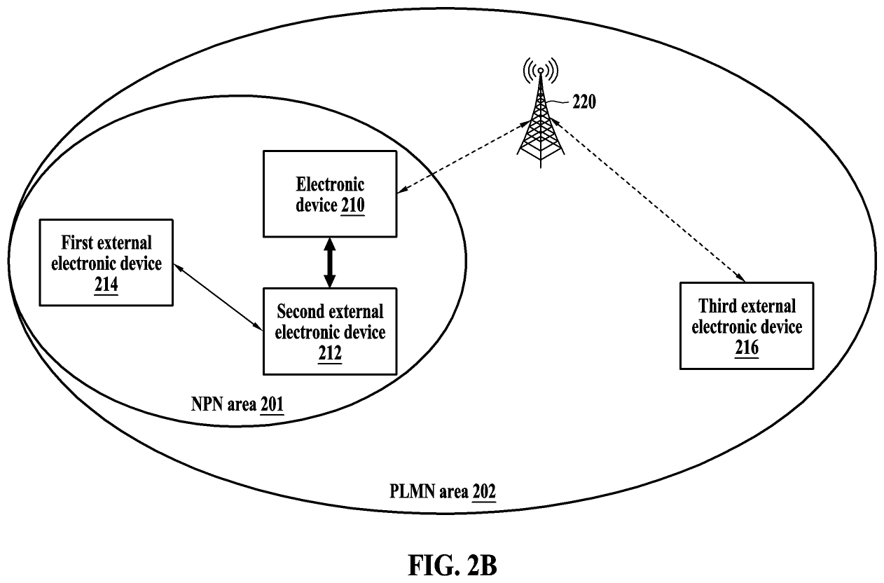

FIG. 2A is a diagram illustrating an example method of providing a call between electronic devices while an electronic device operates in a non-public network (NPN) access mode, according to an embodiment, and FIG. 2B is a diagram illustrating an example method of transferring a call provided between electronic devices as an electronic device operates in a public land mobile network (PLMN) access mode, according to an embodiment.

An electronic device 210 (e.g., the electronic device 101 of FIG. 1) may support both a PLMN access mode and an NPN access mode (e.g., a standalone non-public network (SNPN)), but may not support the PLMN access mode and the NPN access mode at the same time and may selectively operate in either access mode at any point in time. For example, while the electronic device 210 operates in the NPN access mode, the electronic device 210 may make a call as an NPN service to a first external electronic device 214 positioned in an NPN area 201. For example, the electronic device 210 may make a call to the first external electronic device 214 while operating in the NPN access mode and may use another NPN service. The electronic device 210, while operating in the NPN access mode, may not use a PLMN service, for example, like a call to a third external electronic device 216 positioned in a PLMN area 202.

The electronic device 210 may change an access mode of the electronic device 210 to the PLMN access mode to use the PLMN service. According to an embodiment, activation and deactivation of an SNPN access mode may be triggered manually or automatically. For example, as a manual method, the SNPN access mode may be activated as a user prefers to use a SNPN service, or the SNPN access mode may be deactivated as the user prefers to use the PLMN service. The access mode of the electronic device 210 may be changed to the PLMN access mode when the SNPN access mode is deactivated. For example, as an automatic method, the electronic device 210 may activate the SNPN access mode automatically when the user triggers the SNPN service or may deactivate the SNPN access mode automatically when the user triggers the PLMN service.

For example, the electronic device 210, when failing to find an SNPN cell that supports an emergency when making an emergency call, may deactivate the SNPN access mode to find a PLMN cell that supports an emergency. For example, the electronic device 210, when failing to find the PLMN cell that supports an emergency when making an emergency call, may activate the SNPN access mode to find the PLMN cell that supports an emergency.

According to an embodiment, when the access mode of the electronic device 210 is changed from the SNPN access mode to the PLMN access mode, a call performed through the SNPN service between the electronic device 210 and the first external electronic device 214 is disconnected, and thus, to maintain the call, the call needs to be transferred to another electronic device other than the electronic device 210. For example, the call may be transferred to a second external electronic device 212 connected to the electronic device 210 through short-range wireless communication. The short-range wireless communication may be Bluetooth™ and is not limited to said embodiments. For example, the second external electronic device 212 may be a wearable device or an IoT device. A wearable device may include wireless earphones, a smartwatch, smart glasses, or a smart ring but is not limited to said embodiments.

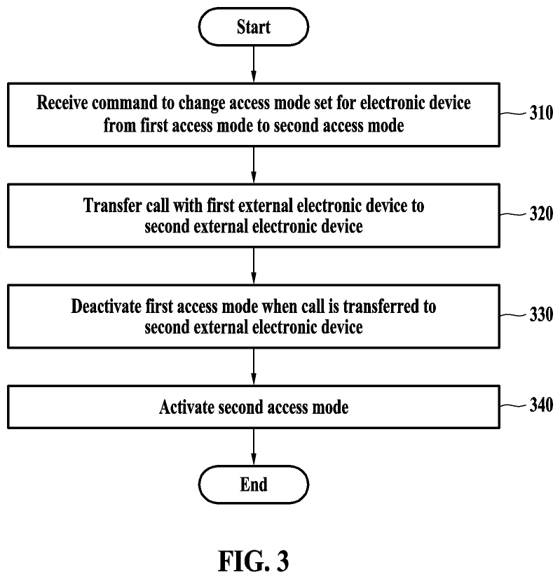

A method of transferring a call between the electronic device 210 and the first external electronic device 214 to a call between the second external electronic device 212 and the first external electronic device 214 is described in greater detail below with reference to FIGS. 3, 4, 5 and 6 (which may be referred to as FIGS. 3 to 6).

When the call between the electronic device 210 and the first external electronic device 214 is transferred to the call between the second external electronic device 212 and the first external electronic device 214, the electronic device 210 may change the access mode to the PLMN access mode and may use the PLMN service. For example, the electronic device 210 may make a call to the third external electronic device 216 through a base station 220 of the PLMN cell.

FIG. 3 is a flowchart illustrating an example method of transferring a call when an electronic device changes an access mode, according to an embodiment.

Operations may be performed sequentially but may not be necessarily performed sequentially. For example, the order of the operations may be changed and at least two of the operations may be performed in parallel.

According to an embodiment, it may be understood that operations 310 to 340 below may be performed by a processor (e.g., the processor 120 of FIG. 1) of an electronic device (e.g., the electronic device 101 of FIG. 1 or the electronic device 210 of FIG. 2A). The electronic device may include at least some of the components of the electronic device 101 described with reference to FIG. 1. For example, the electronic device may include at least one processor (e.g., the processor 120 of FIG. 1) including processing circuitry and memory (e.g., the memory 130 of FIG. 1) including one or more storage media storing instructions.

In operation 310, the electronic device, while performing a call service with a first external electronic device (e.g., the electronic device 102 of FIG. 1 or the first external electronic device 214 of FIG. 2A), may receive a command to change the access mode set for the electronic device from a first access mode to a second access mode. The command to change the access mode may be triggered automatically or manually. For example, the first access mode may use an NPN (e.g., an SNPN), and the second access mode may use a PLMN. For example, the first access mode may use the PLMN, and the second access mode may use the NPN.

For example, the electronic device, by receiving a command to deactivate the first access mode from a user, may receive a command to change the access mode set for the electronic device from the first access mode to the second access mode. For example, the electronic device, by receiving a command to activate the second access mode from a user, may receive a command to change the access mode set for the electronic device from the first access mode to the second access mode.

According to an embodiment, while the electronic device is operating in an NPN access mode, when the user requests a call to an external electronic device (e.g., the third external electronic device 216 of FIG. 2B) positioned in a PLMN cell as a PLMN service, the command to change the access mode may be triggered automatically in the electronic device.

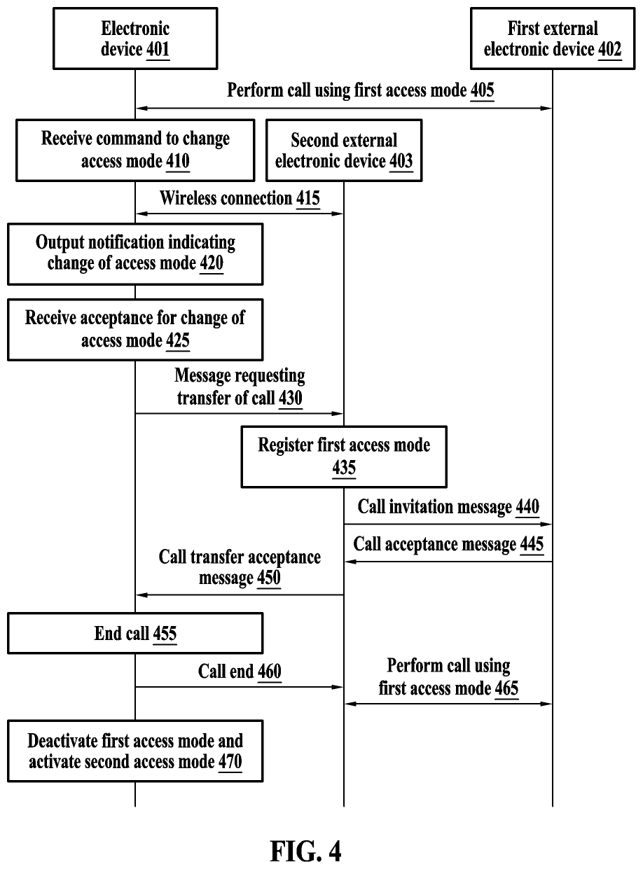

In operation 320, the electronic device may transfer a call with the first external electronic device to the second external electronic device (e.g., the second external electronic device 212 of FIG. 2A) connected to the electronic device. For example, the electronic device may be connected to the second external electronic device through short-range wireless communication, like Bluetooth™. For example, the second external electronic device may be a wearable device or an IoT device. The method of transferring a call is described in greater detail below with reference to FIG. 4.

According to an embodiment, the electronic device may determine the second external electronic device based on performance corresponding to the call service among a plurality of external electronic devices connected to the electronic device. For example, the performance corresponding to a call service may be the quality of a wireless bandwidth or a wireless environment used for the call service.

In operation 330, when the call is transferred to the second external electronic device, the electronic device may deactivate the first access mode. For example, the electronic device may end a call to the first external electronic device and may deactivate the first access mode when the call is ended. For example, the electronic device may end the call to the first external electronic device by deactivating the first access mode.

In operation 340, the electronic device may activate the second access mode. For example, the electronic device whose second access mode is a PLMN access mode may use the PLMN service using the PLMN access mode.

FIG. 4 is a signal flow diagram illustrating an example method of transferring a call when an electronic device changes an access mode, according to an embodiment.

Operations may be performed sequentially but may not be necessarily performed sequentially. For example, the order of the operations may be changed and at least two of the operations may be performed in parallel.

In operation 405, an electronic device 401 (e.g., the electronic device 101 of FIG. 1 or the electronic device 210 of FIG. 2A) may perform a call using a first access mode (e.g., an NPN access mode or a PLMN access mode) between the electronic device 401 and a first external electronic device 402 (e.g., the electronic device 102 of FIG. 1 or the first external electronic device 214 of FIG. 2A).

In operation 410, the electronic device 401 may receive a command to change an access mode. The description of the method of receiving the command to change an access mode may be replaced with the description of operation 310 of FIG. 3.

In operation 415, the electronic device 401 may perform a wireless connection with a second external electronic device 403 (e.g., the second external electronic device 212 of FIG. 2A). When the wireless connection between the electronic device 401 and the second external electronic device 403 is established before operation 405 or operation 410 is performed, operation 415 may not be performed. The second external electronic device 403 may be a wearable device or an IoT device. A wearable device may include wireless earphones, a smartwatch, smart glasses, or a smart ring but is not limited to said embodiments.

In operation 420, the electronic device 401 may output a notification indicating a change of an access mode. For example, the electronic device 401 may output the notification using a display (e.g., the display module 160 of FIG. 1).

In operation 425, the electronic device 401 may receive acceptance for the change of an access mode. For example, a user may transmit an acceptance input to the electronic device 401 in response to the notification displayed on the electronic device 401. For example, the user may transmit the acceptance input to the electronic device 401 by touching the display.

In operation 430, the electronic device 401 may transmit a message requesting transfer of a call to the second external electronic device 403. The electronic device 410 may transmit the message requesting the transfer of the call to the second external electronic device 403 through the wireless connection.

According to an embodiment, the message requesting the transfer of the call may include a request to set (or register) an operation mode of the second external electronic device 403 to the first access mode.

According to an embodiment, the message requesting the transfer of the call may include information on the first external electronic device 402. For example, the information on the first external electronic device 402 may include information that may identify the first external electronic device 402.

According to an embodiment, when the command to change an access mode is received, the electronic device 401 may transmit the message requesting the transfer of the call automatically to the second external electronic device 403. In this case, operations 420 and 425 may be skipped.

In operation 435, the second external electronic device 403 may set (e.g., register) the access mode to the first access mode. When the access mode of the second external electronic device 403 has been already set to the first access mode, operation 435 may be skipped.

In operation 440, the second external electronic device 403 may transmit a call invitation message to the first external electronic device 402. For example, the second external electronic device 403 may transmit the call invitation message to the first external electronic device 402 based on the first access mode. For example, the second external electronic device 403 may transmit the call invitation message to the first external electronic device 402 based on the information on the first external electronic device 402 included in the message requesting the transfer of the call.

In operation 445, the second external electronic device 403 may receive a call acceptance message in response to the call invitation message from the first external electronic device 402. For example, the second external electronic device 403 may receive the call acceptance message from the first external electronic device 402 based on the first access mode.

In operation 450, the second external electronic device 403 may transmit a call transfer acceptance message to the electronic device 401 in response to the call acceptance message.

In operation 455, the electronic device 401 may end the call to the first external electronic device 402 when the call transfer acceptance message is received.

In operation 460, the electronic device 401 may transmit a call end message to the second external electronic device 403. As the call end message is transmitted to the second external electronic device 403, the call between the electronic device 401 and the first external electronic device 402 may be transferred to a call between the second external electronic device 403 and the first external electronic device 402.

In operation 465, a call using the first access mode may be performed between the second external electronic device 403 and the first external electronic device 402. As the call between the electronic device 401 and the first external electronic device 402 is transferred to the second external electronic device 403 connected to the electronic device 401, the call may be performed between the first external electronic device 402 and the second external electronic device 403.

In operation 470, the electronic device 401 may deactivate the first access mode and may activate a second access mode.

According to an embodiment, the electronic device 401 may deactivate the first access mode and may activate the second access mode when the call transfer acceptance message is received. The electronic device 401 may end the call and may transmit the call end message to the second external electronic device 403 when the second access mode is activated.

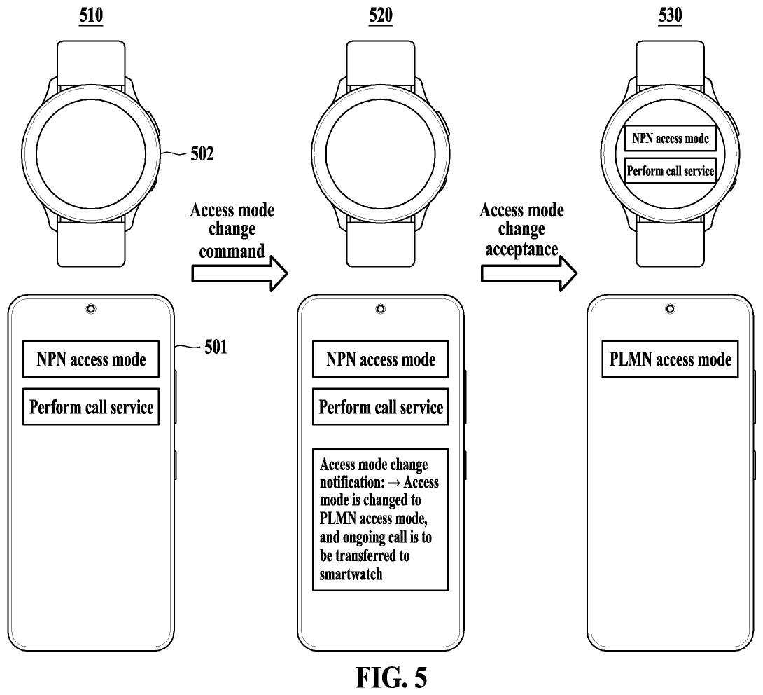

FIG. 5 is a diagram illustrating an example method of changing an access mode set for an electronic device and a wearable device to transfer a call, according to an embodiment.

In operation 510, an electronic device 501 (e.g., the electronic device 101 of FIG. 1, the electronic device 210 of FIG. 2A, or the electronic device 401 of FIG. 4) may perform a call service while operating in an NPN access mode (or a PLMN access mode). A wireless connection may be established between the electronic device 501 and a wearable device 502 (e.g., the second external electronic device 212 of FIG. 2A or the second external electronic device 403).

When the electronic device 501 receives a command to change an access mode set for the electronic device 501 from the NPN access mode to the PLMN access mode, operation 520 may be performed.

In operation 520, the electronic device 501 may output a notification indicating the change of the access mode of the electronic device 401. For example, the electronic device 501 may output the notification using a display (e.g., the display module 160 of FIG. 1).

According to an embodiment, a user may transmit an acceptance input to the electronic device 501 in response to the notification displayed on the electronic device 501. For example, the user may transmit an acceptance input to the electronic device 501 by touching a display area corresponding to the displayed notification. The wearable device 520 may receive a message requesting transfer of a call from the electronic device 501 and may transfer the call based on the received message. The wearable device 520 may set the access mode to the SNPN access mode to transfer the call.

When the electronic device 501 receives the acceptance input for the change of the access mode, operation 530 may be performed.

In operation 530, the electronic device 501 may transfer the ongoing call to the wearable device 520 and may change the access mode to the PLMN access mode. The electronic device 501 may use a PLMN service based on the PLMN access mode.

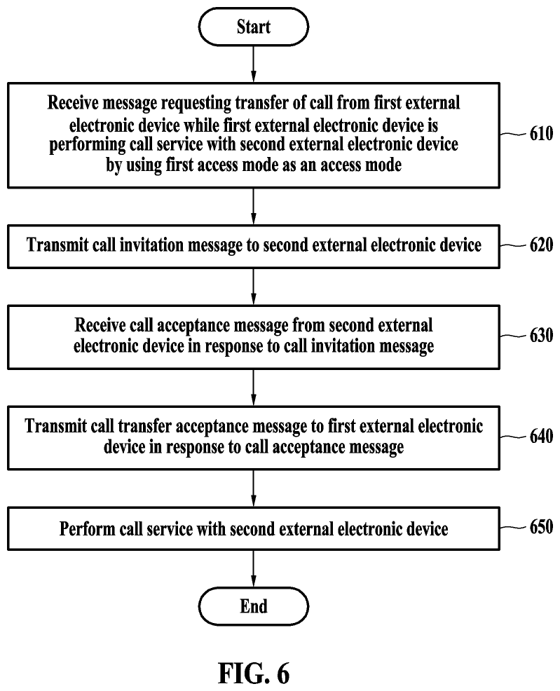

FIG. 6 is a flowchart illustrating an example method of receiving transfer of a call made by an external electronic device, according to an embodiment.

Operations may be performed sequentially but may not be necessarily performed sequentially. For example, the order of the operations may be changed and at least two of the operations may be performed in parallel.

According to an embodiment, it may be understood that operations 610 to 650 below may be performed by a processor (e.g., the processor 120 of FIG. 1) of an electronic device (e.g., the electronic device 101 of FIG. 1, the second external electronic device 212 of FIG. 2A, the second external electronic device 403 of FIG. 4, or the wearable device 502 of FIG. 5). The electronic device may include at least some of the components of the electronic device 101 described with reference to FIG. 1. For example, the electronic device may include at least one processor (e.g., the processor 120 of FIG. 1) including processing circuitry and memory (e.g., the memory 130 of FIG. 1) including one or more storage media storing instructions.

In operation 610, while a first external electronic device (e.g., the electronic device 102 of FIG. 1, the electronic device 210 of FIG. 2A, the electronic device 401 of FIG. 4, or the electronic device 501 of FIG. 5) is performing a call service with a second external electronic device (e.g., the first external electronic device 214 of FIG. 2A or the first external electronic device 402 of FIG. 4) using a first access mode (e.g., an NPN access mode or a PLMN access mode) as an access mode, the electronic device may receive a message requesting the transfer of a call from the first external electronic device. The electronic device may set the access mode to a second access mode. The description of operation 610 may be replaced with the description of operation 425 described above with reference to FIG. 4.

In operation 620, the electronic device may transmit a call invitation message to the second external electronic device. The description of operation 620 may be replaced with the description of operation 435 described above with reference to FIG. 4.

In operation 630, the electronic device may receive a call acceptance message from the second external electronic device in response to the call invitation message. The description of operation 630 may be replaced with the description of operation 440 described above with reference to FIG. 4.

In operation 640, the electronic device may transmit a call transfer acceptance message to the first external electronic device in response to the call acceptance message. The description of operation 640 may be replaced with the description of operation 445 described above with reference to FIG. 4.

In operation 650, the electronic device may perform a call service with the second external electronic device. The electronic device may receive a call end message from the first external electronic device in response to the call transfer acceptance message. When the call end message is received, a call service may be performed between the electronic device and the second external electronic device.

According to an example embodiment, an electronic device may include: at least one processor, comprising processing circuitry, and memory including one or more storage media storing instructions, wherein the instructions, when executed individually or collectively by the at least one processor, cause the electronic device to: while performing a call service with a first external electronic device using a first access mode as an access mode set for the electronic device, receive a command to change the access mode set for the electronic device from the first access mode to a second access mode, transfer a call with the first external electronic device to a second external electronic device connected to the electronic device ; based on the call being transferred to the second external electronic device, deactivate the first access mode, and activate the second access mode.

According to an example embodiment, the first access mode includes a mode using an NPN, and the second access mode includes a mode using a PLMN.

According to an example embodiment, the electronic device may be connected to the second external electronic device using short-range wireless communication.

In an example embodiment, the second external electronic device may be a wearable device or an IoT device.

According to an example embodiment, the instructions, when executed individually or collectively by the at least one processor, cause the electronic device to: by receiving a command to deactivate the first access mode or receiving a command to activate the second access mode, receive a command to change the access mode set for the electronic device from the first access mode to the second access mode.

According to an example embodiment, the instructions, when executed individually or collectively by the at least one processor, cause the electronic device to: in response to receiving the command to change the access mode from the first access mode to the second access mode, transmit the message requesting the transfer of the call to the second external electronic device, in response to the message, receive a message notifying the transfer of the call is accepted from the second external electronic device, and, in response to receiving the message notifying the transfer of the call is accepted, end the call with the first external electronic device.

According to an example embodiment, the message requesting the transfer of the call may include a request to set an operation mode of the second external electronic device to the first access mode.

According to an example embodiment, the message requesting the transfer of the call may include information on the first external electronic device.

According to an example embodiment, based on the call with the first external electronic device being transferred to the second external electronic device connected to the electronic device, a call between the first external electronic device and the second external electronic device may be performed.

According to an example embodiment, the instructions, when executed individually or collectively by the at least one processor, cause the electronic device to: determine the second external electronic device based on performance corresponding to the call service among a plurality of external electronic devices connected to the electronic device.

According to an example embodiment, a method performed by an electronic device may include: while performing a call service with a first external electronic device using a first access mode as an access mode set for the electronic device, receiving a command to change the access mode set for the electronic device from the first access mode to a second access mode, transferring a call with the first external electronic device to a second external electronic device connected to the electronic device, based on the call being transferred to the second external electronic device deactivating the first access mode, and activating the second access mode.

According to an example embodiment, the first access mode may be a mode using an NPN, the second access mode may be a mode using a PLMN, and the electronic device may be connected to the second external electronic device using short-range wireless communication.

According to an example embodiment, the transferring a call with the first external electronic device to a second external electronic device connected to the electronic device may include: in response to receiving the command to change the access mode from the first access mode to the second access mode, transmitting the message requesting the transfer of the call to the second external electronic device, in response to the message, receiving a message notifying the transfer of the call is accepted from the second external electronic device, and, in response to receiving the message notifying the transfer of the call is accepted, ending the call with the first external electronic device.

According to an example embodiment, the method may include determining the second external electronic device based on performance corresponding to the call service among a plurality of external electronic devices connected to the electronic device.

According to an example embodiment, an electronic device includes: at least one processor, comprising processing circuitry, and memory including one or more storage media storing instructions, wherein the instructions, when executed individually or collectively by the at least one processor, cause the electronic device to: while a first external electronic device is performing a call service with a second external electronic device using a first access mode, receive a message requesting transfer of a call from the first external electronic device, transmit a call invitation message to the second external electronic device, receive a call acceptance message in response to the call invitation message from the second external electronic device, transmit a call transfer acceptance message in response to the call acceptance message from the first external electronic device, and perform a call service with the second external electronic device.

According to an example embodiment, wherein the first access mode is an NPN or a PLMN.

According to an example embodiment, the message requesting the transfer of the call may include a request to set an access mode of the electronic device to the first access mode.

According to an example embodiment, the message requesting the transfer of the call may include information on the second external electronic device.

According to an example embodiment, the electronic device may include a wearable device or an IoT device.

The effects to be achieved are not limited to those described above, and other effects not mentioned above will be clearly understood by one of ordinary skill in the art.

The electronic device according to various embodiments may be one of various types of electronic devices. The electronic device may include, for example, a portable communication device (e.g., a smartphone), a computer device, a portable multimedia device, a portable medical device, a camera, a wearable device, a home appliance device, or the like. The electronic device according to various example embodiments of the present disclosure is not limited to the devices described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., by wire), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an example, the module may be implemented in a form of an application-specific integrated circuit (ASIC).

Various embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to embodiments of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, according to an embodiment, the integrated component may still perform one or more functions of each of the plurality of components in the same or similar manner as they are performed by a corresponding one among the plurality of components before the integration. According to various example embodiments, operations performed by the module, the program, or another component may be carried out sequentially, in parallel, repeatedly, or heuristically, or one or more of the operations may be executed in a different order or omitted, or one or more other operations may be added.

The example embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an OS and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random-access memory (RAM), flash memory, and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the various example embodiments have been described with reference to the drawings, one skilled in the art may apply various technical modifications and variations based thereon. Suitable results may be achieved when the described techniques are performed in a different order, and/or if components in a described system, architecture, device, or circuit are combined in a different manner, and/or replaced or supplemented by other components or their equivalents.

Therefore, various implementations, various examples, and equivalents to the claims are also within the scope of the disclosure, including the appended claims.

What is claimed is:

1. An electronic device comprising:
at least one processor comprising processing circuitry; and
memory comprising one or more storage media storing instructions,
wherein the instructions, when executed individually or collectively by the at least one processor, cause the electronic device to:
while performing a call service with a first external electronic device using a first access mode as an access mode set for the electronic device, receive a command to change the access mode set for the electronic device from the first access mode to a second access mode,
transfer a call with the first external electronic device to a second external electronic device connected to the electronic device,
based on the call being transferred to the second external electronic device, deactivate the first access mode, and
activate the second access mode.

2. The electronic device of claim 1, wherein the first access mode includes a mode using a non-public network (NPN), and the second access mode includes a mode using a public land mobile network (PLMN).

3. The electronic device of claim 1, wherein the electronic device is connected to the second external electronic device using short-range wireless communication.

4. The electronic device of claim 3, wherein the second external electronic device includes a wearable device or an Internet-of-things (IoT) device.

5. The electronic device of claim 1, wherein the instructions, when executed individually or collectively by the at least one processor, cause the electronic device to:
by receiving a command to deactivate the first access mode or receiving a command to activate the second access mode, receive a command to change the access mode set for the electronic device from the first access mode to the second access mode.

6. The electronic device of claim 1, wherein the instructions, when executed individually or collectively by the at least one processor, cause the electronic device to:
in response to receiving the command to change the access mode from the first access mode to the second access mode, transmit the message requesting the transfer of the call to the second external electronic device,
in response to the message, receive a message notifying the transfer of the call is accepted from the second external electronic device, and,
in response to receiving the message notifying the transfer of the call is accepted, end the call with the first external electronic device.

7. The electronic device of claim 1, wherein the message requesting the transfer of the call comprises a request to set an operation mode of the second external electronic device to the first access mode.

8. The electronic device of claim 1, wherein the message requesting the transfer of the call comprises information on the first external electronic device.

9. The electronic device of claim 1, wherein, as the call with the first external electronic device is transferred to the second external electronic device connected to the electronic device, a call between the first external electronic device and the second external electronic device is performed.

10. The electronic device of claim 1, wherein the instructions, when executed individually or collectively by the at least one processor, cause the electronic device to:
determine the second external electronic device based on performance corresponding to the call service among a plurality of external electronic devices connected to the electronic device.

11. A method performed by an electronic device, the method comprising:
while performing a call service with a first external electronic device using a first access mode as an access mode set for the electronic device, receiving a command to change the access mode set for the electronic device from the first access mode to a second access mode;
transferring a call with the first external electronic device to a second external electronic device connected to the electronic device;
based on the call being transferred to the second external electronic device, deactivating the first access mode; and
activating the second access mode.

12. The method of claim 11, wherein
the first access mode is a mode using a non-public network (NPN), and the second access mode is a mode using a public land mobile network (PLMN), and
the electronic device is connected to the second external electronic device using short-range wireless communication.

13. The method of claim 11, wherein
the transferring a call with the first external electronic device to a second external electronic device connected to the electronic device comprises:
in response to receiving the command to change the access mode from the first access mode to the second access mode, transmitting the message requesting the transfer of the call to the second external electronic device;
in response to the message, receiving a message notifying the transfer of the call is accepted from the second external electronic device; and,
in response to receiving the message notifying the transfer of the call is accepted, ending the call with the first external electronic device.

14. The method of claim 11, further comprising:
determining the second external electronic device based on performance corresponding to the call service among a plurality of external electronic devices connected to the electronic device.

15. A non-transitory computer-readable storage medium storing instructions that, when executed by at least one processor, cause an electronic device to perform the method of claim 11.

16. An electronic device comprising:
at least one processor comprising processing circuitry; and
memory comprising one or more storage media storing instructions,
wherein the instructions, when executed individually or collectively by the at least one processor, cause the electronic device to:
while a first external electronic device is performing a call service with a second external electronic device using a first access mode, receive a message requesting transfer of a call from the first external electronic device,
transmit a call invitation message to the second external electronic device,
receive a call acceptance message in response to the call invitation message from the second external electronic device,
transmit a call transfer acceptance message in response to the call acceptance message from the first external electronic device, and
perform a call service with the second external electronic device.

17. The electronic device of claim 16, wherein
the first access mode is a mode using a non-public network (NPN) or a public land mobile network (PLMN).

18. The electronic device of claim 16, wherein the message requesting the transfer of the call comprises a request to set an access mode of the electronic device to the first access mode.

19. The electronic device of claim 16, wherein the message requesting the transfer of the call comprises information on the second external electronic device.

20. The electronic device of claim 16, wherein the electronic device includes a wearable device or an Internet-of-things (IoT) device.
